(19) United States
(12) Patent Application Publication
(10) Pub. No.: US 2026/0321219 A1
(43) Pub. Date: Oct. 15, 2026

(54) DYNAMICALLY UPDATABLE PERSISTENT DISPLAYS FOR HARDWARE RESOURCES

(71) Applicant: Nvidia Corporation, Santa Clara, CA (US)

(72) Inventors: Jordan Levy, Portland, OR (US); Ryan Albright, Beaverton, OR (US); William Andrew Mecham, Elk Grove, CA (US); William Ryan Weese, Portland, OR (US); Benjamin Goska, Portland, OR (US); Aaron Carkin, Hillsboro, OR (US); Richard Burton Finch, Largo, FL (US); Scott Millward, San Jose, CA (US)

(21) Appl. No.: 19/179,936

(22) Filed: Apr. 15, 2025

(51) Int. Cl. G09G 3/34; G09G 3/00

(52) U.S. Cl. CPC G09G 3/3453; G09G 3/035; G09G 3/344; G09G 3/3466; G09G 3/348; G09G 2354/00; G09G 2370/16; G09G 2380/04

(57) ABSTRACT

Persistent displays such as E-ink persistent displays can convey information related to hardware components such as servers, GPUs, and network switches, regardless of the operational status or power state of those displays. The displays can store data, including error codes, status information, and configuration details from connected hardware. Additionally, the persistent display systems allow for dynamic updates by users or administrators.

### TECHNICAL FIELD

This disclosure relates to the use of persistent displays showing information about hardware components optionally without power.

### BACKGROUND

Identifying and tracking hardware resources is important for organizations relying on data centers. Some hardware resources have relied on serial number stickers and barcodes, which may be cumbersome and prone to human error. For example, users must frequently carry scanning devices to look up information, leading to inefficiencies and potential misidentifications. Furthermore, the reliance on a centralized database means that any discrepancies or outdated information can result in significant operational delays, especially during upgrades or repairs. As data centers evolve and hardware components are frequently swapped out, the inability to quickly and accurately identify these components can hinder maintenance efforts and increase downtime.

### BRIEF DESCRIPTION OF THE DRAWINGS

Various embodiments in accordance with the present disclosure will be described with reference to the drawings, in which:

FIG. 1 illustrates a system for connecting and powering an E-ink persistent device according to example embodiments;

FIGS. 2A-2E illustrate electronic ink persistent displays according to example embodiments;

FIG. 2F illustrates a process for maintaining a display of hardware information despite power loss according to example embodiments;

FIG. 3 illustrates a system for updating an electronic ink persistent display according to example embodiments;

FIG. 4A illustrates a system for operating an electronic ink persistent display with an operational power source according to example embodiments;

FIG. 4B illustrates a system for operating an electronic ink persistent display with a non-operational power source according to example embodiments;

FIGS. 5A-5C illustrate processes for displaying state data on an electronic ink persistent display according to example embodiments;

FIG. 6 illustrates components of a distributed computing system that can be used to receive and manage data according to example embodiments;

FIG. 7 illustrates an example data center system according to example embodiments;

FIG. 8 illustrates a computing system according to example embodiments;

FIG. 9 is a block diagram illustrating a computer system with a parallel processing system according to example embodiments;

FIG. 10 illustrates a computing system according to example embodiments;

FIG. 11 illustrates a computing system according to example embodiments;

FIG. 12 is a block diagram illustrating a computer system according to example embodiments; and

FIG. 13 illustrates a computing system with a parallel processor according to example embodiments.

### DETAILED DESCRIPTION

Embodiments discussed herein relate to the use of persistent displays (e.g., E-ink persistent displays or electrophoretic tags) to convey information for hardware components (e.g., servers, GPUs, network switches, etc.) independent of whether those underlying components have power or are operational. A persistent display as used herein may include any electronic paper (e.g., E-Ink) type of display that can be dynamically updated to display current information but is also able to hold that displayed content static and visible indefinitely without power or further communication. The persistent display can take the form of a small tag, tab, sticker, label, or thin device that is able to be attached to the exterior of a hardware device, such as the back of a server in a rack, or able to be pulled or slid out from a casing of such a hardware device, among other similar options. The display can receive data from the hardware device to which it is connected, such as to receive post codes, error codes, or status information from a baseboard management controller (BMC) or complex programmable logic device (CPLD). In some embodiments, the persistent display can also, or alternatively, display information about a hardware device, such as its serial number, manufacturer, model, SKU, currently installed software, hardware version and components, log message, session identifier, user identifier, recently completed task identifier, and other such configuration information. The persistent display can be dynamically updated (e.g., by a user or administrator via a computing device) to include other state or status information, such as that may be useful for identification, tracking, or maintenance purposes. When a hardware device loses power, experiences a failure, or is to be shut down, relevant information for that hardware device can be written to the persistent display that may help in troubleshooting the device (or at least understanding the reason for the action). In some example embodiments, the persistent display can include its own processor and memory, allowing it to interface with existing controllers in a system. The memory and at least one interface element may allow for viewing past or prior information written to the display, or to see additional content that would not all fit on a viewable region of the display at one time. The persistent display may include a small battery to allow for such interaction even if the device is not otherwise powered. The data to be displayed may be referred to as state data to include without limitation error codes, recent operations, changes to software, status message, and other similar data.

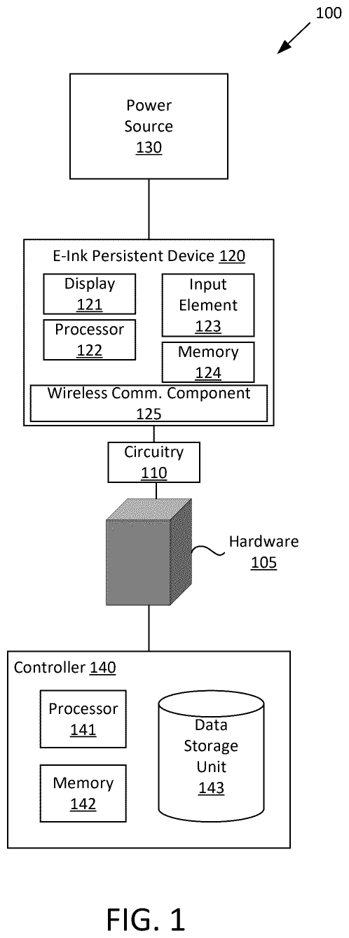

FIG. 1 illustrates a system 100 for updating an E-ink persistent device 120 upon receiving one or more updated state data associated with hardware 105. The system 100 can include an E-ink persistent device 120, hardware 105, circuitry 110, a power source 130, and a controller 140.

The hardware 105 can include one or more hardware components, including, without limitation, servers, server racks, CPUs, GPUs, network switches, storage devices, inter-integrated circuits (i2Cs), and any other hardware elements discussed elsewhere herein. In a data center environment, additional hardware components may include load balancers, firewalls, and power distribution units (PDUs), which help manage and distribute electrical power to various devices. The E-ink persistent device 120 may be located anywhere on or proximate the hardware 105, including within an externally-accessible slot in the hardware device, and wherein the display device is able to be at least partially removed from the externally-accessible slot to allow the state data to be read from the persistent display.

The circuitry 110 may connect the hardware 105 to the E-ink persistent device 120. The circuitry 110 may include connectors, signal processors, voltage regulators, and communication interfaces such as USB, Ethernet, or serial ports. The circuitry 110 may facilitate the transmission of one or more pieces of information, such as state data, about the hardware 105 to the E-ink persistent device 120.

The E-ink persistent device 120 may include a display 121, a processor 122, an input element 123, a memory 124, and a wireless communication component 125. The E-ink persistent device 120 may use electronic ink in its display 121. Generally, E-ink utilizes microcapsules filled with black and white particles that rearrange themselves when an electric field is applied, allowing for low-power and no-power displays. In other example embodiments, the display 121 persistent display is one of an electronic paper display, an electrophoretic display, a plasmonic display, an electrowetted display, or an interferometric display.

A processor 122 may read one or more instructions from the memory 124. The processor may render any information or updated state data to be displayed on the display 121. In example embodiments, the E-ink persistent device 120 may receive one or more updated pieces of information or state data from the hardware 105 via the circuitry 110 one or more times, continuously, iteratively, or in any predetermined time period. The processor may, based on this updated information or state data, update the display 121 to show one or more visual elements on the display 121. In some example embodiments, this display information may include error messages, hardware status indicators, temperature readings, and operational metrics. The processor 122 may include a central processing unit (CPU) or graphics processing unit (GPU)), data processing units (DPUs), quantum processing units (QPUs), a plurality of parallel processing units (PPUs), and application-specific integrated circuits (ASICs) memory module, or power supply. QPUs configured to perform one or more operations associated with a quantum algorithm. In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with.

Furthermore, the memory 124 may store the information or updated state data for later use. The memory 124 may take the form of any non-transitory computer-readable medium or combination of such media, some examples including flash memory, ROM, and RAM as any one or more types of non-transitory data-storage technology deemed suitable by those of skill in the relevant art can be used. In at least one embodiment, the memory 124 contains instructions that are executable by the processor 122 for carrying out various functions described herein as being carried out on or by the system 100. In at least some embodiments, the instructions include an application executable by the processor 122 to carry out such functions.

The E-ink persistent display 120 may be associated with individual servers to provide real-time status updates, such as CPU load or memory usage, or it may be mounted on server racks to display aggregated information for all servers within that rack, such as overall health status or alerts for any hardware failures. Furthermore, the E-ink persistent display 120 could be integrated with environmental monitoring devices that track temperature and humidity levels, providing information about the data center's operating conditions. Additionally, the display 121 could be used in conjunction with backup systems, such as uninterruptible power supplies (UPS), to show battery status and remaining runtime, ensuring that administrators have immediate access to vital information regarding the data center's infrastructure.

Additionally, the E-ink persistent device 120 may include an input element 123 that allows one or more users or administrators to transmit inputs to the E-ink persistent device 120. In example embodiments, a user may manually input or request an input to be made into the E-ink persistent device 120 via the input element 123. In other embodiments, the user or administrator may interact with the input element 123 via a user device, administrator device, smart device, or any such computing device. In example embodiments, the user may interact with the input element 123 in order to display the most recent state data, restart the E-ink persistent device 120, or configure device settings. Furthermore, the input element 123 may include one or more input devices and one or more output devices. With respect to input devices, the input element 123 may include one or more touchscreens, keyboards, mice, trackpads, touchpads, other pointing devices, buttons, switches, knobs, microphones, and/or the like. With respect to output devices, the input element 123 may include one or more displays (e.g., the display 121), monitors, speakers, light-emitting diodes (LEDs), and/or the like. Moreover, one or more components of the input element 123 could provide both user-input and user-output functionality. For example, the input element 123 could be an interactive touchscreen-and-display component.

The power source 130 may be an external power source powering at least the E-ink persistent device 120, the hardware 105, and the controller 140. The power source 130 may include AC power supplies, DC power supplies, uninterruptible power supplies (UPS), or battery backup systems. The power source 130 may be responsible for powering one or more sections of a data center. When the power source 130 is on, the E-ink persistent device 120 may receive one or more updated pieces of information or state data from the hardware 105. Due to the nature of E-ink and the E-ink persistent device 120, the E-ink persistent device 120 may continue to operate its display 121 even when the power source 130 is not in operation. In example embodiments, the display 121 will continue to show its most recent display of state data in the event that the power source 130 is cut off or lost. This allows users or administrators to view the display 121 even when power is lost, enabling them to access the most recent update or state information from the hardware 105, which may be helpful in understanding why power was lost, what the hardware was doing right before power was lost, or diagnosing any number of software or hardware issues in the data center.

The controller 140 may include a processor 141, memory 142, and data storage unit 143. The controller 140 may include a processor 141, memory 142, and a data storage unit 143. The controller 140 may be connected to the hardware 105 via a wired or wireless connection. The controller 140 may be configured to transmit and receive information or state data from the hardware 105, as well as configure the display 121 of the E-ink persistent device 120. The controller 140 may include an interface for a user or administrator to interact with the hardware and the E-ink persistent device 120. For example, a user may access the controller 140 remotely through a web-based interface or a dedicated application on a smart device. This interface would allow the user to view the current state data displayed on the E-ink persistent device 120, such as system alerts or operational metrics. The user could also edit the content displayed on the E-ink persistent device 120 by selecting different data points or visual elements to be shown. Additionally, the user could access the memory of the E-ink persistent device 120 to review historical logs, which may include past state data, error messages, or operational history. This capability would allow the user to monitor and manage the hardware 105 effectively, even if they are not physically present next to the E-ink persistent device 120. For instance, if a user notices an alert indicating a hardware failure, they could use the controller 140 to investigate the historical log for any preceding error messages that might provide insight into the issue.

The processors 122 and 141 may include one or more processors of any type deemed suitable by those of skill in the relevant art, some examples including a general-purpose microprocessor and a dedicated digital signal processor (DSP). The processors can include one or more microprocessors, one or more microcontrollers, one or more microchips, one or more ASICs, one or more FPGAs, one or more GPUs, one or more TPUs, and/or one or more processing devices and/or processing components of any other type.

Furthermore, the processing steps referenced in FIG. 1 and elsewhere may comprise one or more modules. Furthermore, in this disclosure, one or more components of one or more devices, systems, and/or the like are referred to as modules that carry out (i.e., perform, execute, and the like) various functions. As used in the present disclosure, a module includes both hardware and instructions. The hardware can include one or more processors, one or more microprocessors, one or more microcontrollers, one or more microchips, one or more application-specific integrated circuits (ASICs), one or more field programmable gate arrays (FPGAs), one or more graphical processing units (GPUs), one or more tensor processing units (TPUs), and/or one or more devices and/or components of any other type deemed suitable by those of skill in the art for a given implementation. In some cases, a module includes at least one functional component (e.g., an application or part of an application, a block of code, and/or the like) executing in whole or in part on one or more processors of a host system or device.

The instructions for a given module are executable by the hardware for carrying out the one or more herein-described functions of the module, and can include hardware (e.g., hardwired) instructions, firmware, software, and/or the like, stored in any one or more non-transitory computer-readable media deemed suitable by those of skill in the art for a given implementation. Each such computer-readable medium can be or include memory (e.g., random access memory (RAM), read-only memory (ROM), erasable programmable read-only memory (EPROM), electrically erasable programmable read-only memory (EEPROM a.k.a. EPROM), flash memory, and/or one or more other types of memory) and/or one or more other types of non-transitory computer-readable medium. A module can be realized as a single component or be distributed across multiple components as deemed suitable by those of skill in the art.

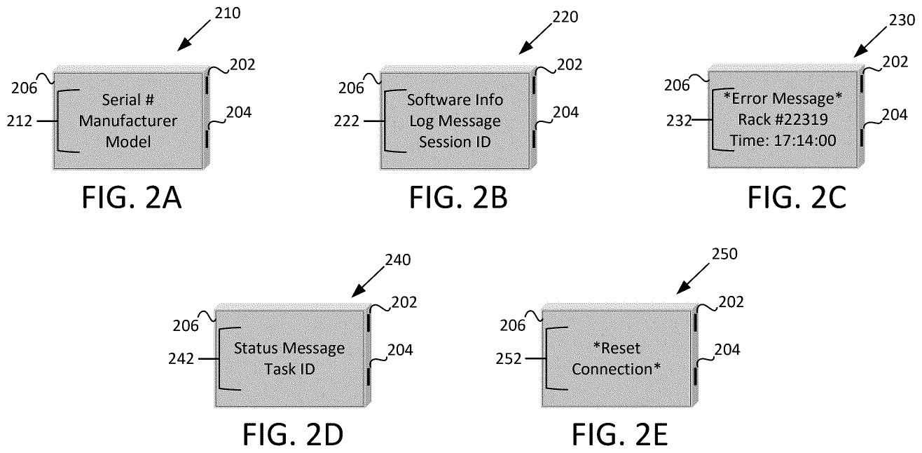

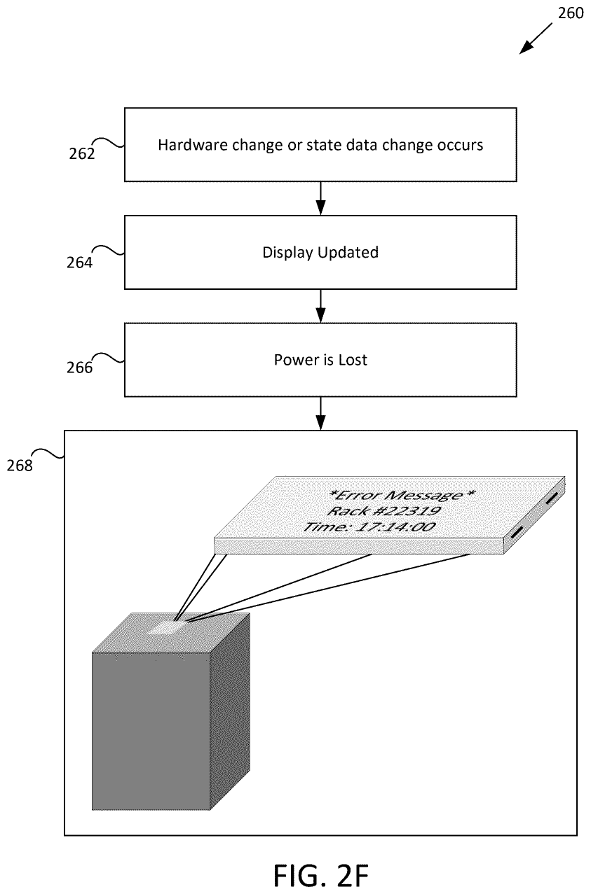

FIGS. 2A-2F illustrate one or more E-ink persistent displays 210-250 to convey one or more hardware information, task information, or other relevant information associated with hardware components described elsewhere herein. Each of the E-ink persistent displays 210-250 includes one or more communication ports 202 and power connection ports 204. The communication ports 202 are designed to connect the E-ink persistent displays 210-250 to one or more controllers or hardware components from which the E-ink persistent displays may retrieve information. Additionally, these ports may allow a separate device, such as a reader, to plug into the communication port to interface with the E-ink persistent display. The power connection port 204 is configured to interface with one or more power connection elements, such as cords or other connecting elements, to connect the display with an external power source or even a battery. Furthermore, each of the E-ink persistent displays includes a display 206. The display 206 may consist of an E-ink screen that allows a user to view the information presented. The display can be backlit or not backlit, depending on the connection to power. However, the E-ink persistent display remains visible even without backlighting due to the reflective properties of the E-ink technology. In various example embodiments, the E-ink persistent displays 210-250 can convey different types of information, including, without limitation, information about a hardware component (referred to as hardware device), such as its serial number, manufacturer, model, SKU, currently installed software, hardware version and components, post code, error code, log message, session identifier, user identifier, recently completed task identifier, and other configuration information. The persistent display can be dynamically updated (e.g., by a user or administrator via a user interface computing device) to include other state or status information, which may be useful for identification, tracking, or maintenance purposes. Although FIGS. 2A-2E illustrate displays featuring only a limited amount of information, it is understood that in other example embodiments, the E-ink persistent displays can convey any kind of similar information not described herein. Furthermore, it is understood that the E-ink persistent displays can convey more or less information than illustrated, and that the E-ink persistent displays can represent multiple categories of information, for example, a first category of information at a first time period, followed by a second category of information at a subsequent time period.

The E-ink persistent displays also allow for user configuration via one or more interfaces, such as the communication port 202 or the wireless communication component 125. As a non-limiting example, a user can interface with the E-ink persistent display to request the display to recall one or more pieces of information about the corresponding hardware or otherwise interact with the memory and information stored by the E-ink persistent display or the corresponding controller.

The E-ink persistent display can be constructed from a variety of materials that contribute to its functionality and flexibility. The display may consist of a flexible substrate, such as polyethylene terephthalate (PET) or other polymer films, which allows it to bend and conform to different surfaces. The electronic ink itself may be comprised of microcapsules containing black and white particles suspended in a clear fluid. When an electric field is applied, these particles move to the surface of the display, creating visible text or images.

In terms of backlighting, the E-ink persistent display may not require a backlight, as it reflects ambient light, similar to paper. However, in some example embodiments, a low-power front light or edge lighting could be integrated to enhance visibility in low-light conditions. The E-ink persistent display may also feature an adhesive backing, allowing it to be affixed directly to hardware resources or surfaces. This adhesive could be designed for easy removal and reapplication, enabling the display to be repositioned as needed. Additionally, the display could incorporate a mating mechanism, such as magnetic strips or clips, to secure it to hardware resources while allowing for quick detachment. Furthermore, the E-ink persistent display could include Near Field Communication (NFC) capabilities, enabling users to hold a compatible device close to the display to retrieve information or interact with the device wirelessly. This feature could facilitate quick access to data without the need for physical contact.

FIG. 2A illustrates the E-ink persistent display 210 displaying a serial number, manufacturer, and model information 212 regarding one or more hardware components associated with the E-ink persistent display 210. FIG. 2B illustrates an E-ink persistent display 220 presenting software information, a log message, and a session identification (ID) 222. The software information, log message, and session ID might include the following examples: software version number (e.g., “v1.2.3”), a log message indicating the last successful operation (e.g., “Last operation successful at 10:30 AM”), and a session ID (e.g., “Session ID: 456789”). FIG. 2C illustrates an E-ink persistent display 230 displaying an error message, rack number, and a timestamp 232. In example embodiments, this E-ink persistent display 230 is useful when there is a hardware or software malfunction, or when the hardware corresponding to the E-ink persistent display 230 has lost power. In such example embodiments, the E-ink persistent display 230 can maintain the display of the error message even without power, thereby assisting users in diagnosing the cause of the error. FIG. 2D illustrates an E-ink persistent display 240 displaying information 242, including a status message and task identifier. In example embodiments, the status message and task identifier might include a status message such as “Operational” and a task identifier like “Task ID: 12345—Firmware Update in Progress.” FIG. 2E illustrates an E-ink persistent display 250 displaying information 252, such as a user prompt “Reset Connection,” prompting the user to reset a connection between the hardware and one or more corresponding components. This prompt may appear as a consequence of one or more hardware, software, or operational errors.

FIG. 2F illustrates a process 260 for operating the E-ink persistent device in the event of power loss. It should be noted that any of these actions may be performed one or more times or in an order different from that illustrated in FIG. 2F.

In the process 260, the E-ink persistent device may receive 262 one or more hardware changes or state data updates from one or more hardware components across circuitry. Upon receiving this updated hardware change or state data change, the E-ink persistent device may update 264 its E-ink persistent display accordingly. In example embodiments, the E-ink persistent display may be updated to reflect the recently received hardware change or state data change. In some example embodiments, power to the E-ink persistent device or associated hardware may be reduced or lost 266. In some E-ink persistent display devices, loss of power would mean loss of the ability to view any information or message that would typically be displayed on such devices. However, due to the nature of E-ink and E-ink persistent devices as described herein, loss of power does not equate to loss of display functionality. In action 268, the E-ink persistent display may show the most recent displayable element, hardware change, or state data change prior to the power loss period. As illustrated in FIG. 2F, the E-ink persistent display may show an error message along with other identifying information, such as the identification of the hardware (e.g., rack number 22319) and the time when this information was last displayed prior to the power loss period. In example embodiments, a user or administrator may be able to view this message on the display of the E-ink persistent device despite the loss of power. In such example embodiments, a dedicated section of the display could be reserved for always-visible metadata, such as a unique tag identifier (e.g., Tag #123ABC) or other relevant information about the display itself. This would provide users with immediate context regarding the specific display or the hardware with which it is associated.

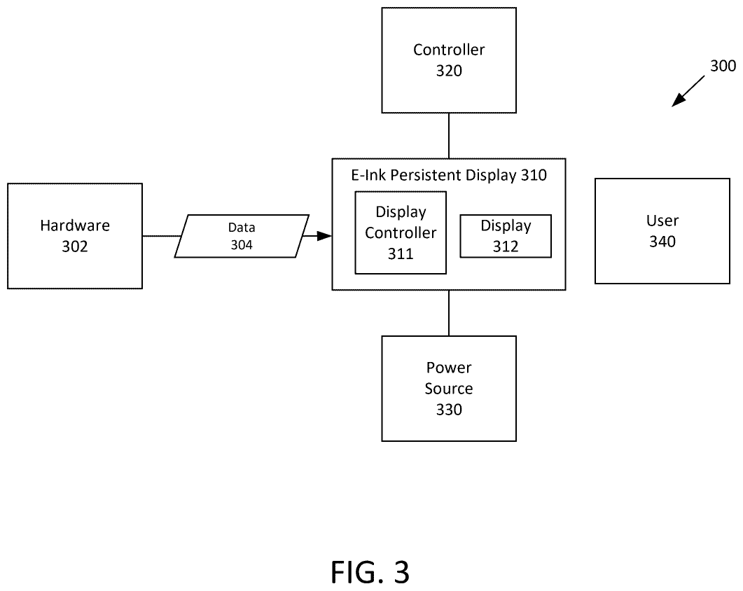

FIG. 3 illustrates a system 300 for updating an E-ink persistent display upon receiving updated state data, an error message, or any other data received from a hardware component to the E-ink persistent display. As described elsewhere herein, the E-ink persistent display 310 may be present on one or more hardware components, including, without limitation, a data center or other suitable collection of hardware. In the system 300, hardware 302 may be operating across one or more time periods. During one of these time periods, the hardware 302 may update or generate one or more pieces of information, state data, metrics, measurements, or any other similarly situated data. Example embodiments of state data that might be used in this situation include server performance metrics such as CPU utilization, memory usage, and disk I/O rates. In example embodiments, a CPU might be updated to reflect its current clock speed, core temperatures, and power consumption levels. A GPU could provide updates on rendering load, memory bandwidth usage, and thermal status. Additionally, network devices may report on packet loss, latency, and bandwidth utilization.

In example embodiments, the hardware 302 might generate data 304 such as state data, data indicating a glitch, error, or malfunction, or other similar data 304 emanating from a software or hardware problem associated with the hardware 302. Although not illustrated in FIG. 3 or the system 300, the data may be transmitted wirelessly or wired over a network, such as the circuitry discussed with further reference to FIG. 1. The data may be transmitted to the E-ink persistent display 310.

The E-ink persistent display 310 may include a display controller 311 and a display 312. When the E-ink persistent display 310 receives the data 304, the display controller 311 may process the data 304 and consequently update the persistent display 312 to show the updated state information contained in the data 304. By including only a display 312 and corresponding display controller 311, the E-ink persistent display 310 may be small, lightweight, or otherwise easier to manage that the E-ink persistent display illustrated in FIG. 1 which includes additional elements besides a display and controller. In FIG. 3, the hardware 302 may transmit data 304 directly to the E-ink persistent display 310, or to the controller, or both. The controller 302 may process the data 304 before transmitting it to the E-ink persistent display 310. In other embodiments, the E-ink persistent display 310 and controller 320 may interface to retrieve historical data or other hardware information. The controller 320 may also receive the data 304, determine what information should be displayed on the E-ink persistent display 310, then transmit a command or query to the E-ink persistent display 310 allowing the E-ink persistent display 310 to display the determined information, such as any of the information discussed with regard to FIGS. 2A-2F.

The act of updating the display 312 may involve applying an electric charge to the microcapsules within the E-ink persistent display. This charge causes the black and white particles suspended in the microcapsules to rearrange, thereby changing the visual output on the display. For instance, if the data indicates a hardware failure, the display may change to show a warning icon along with the data. The hardware involved in this process may include the processor 311, which executes the necessary algorithms to interpret the incoming data, and the display driver circuitry that controls the application of the electric charge to the E-ink persistent display.

The E-ink persistent display 310 may be further connected to a controller 320 and a power source 330. The controller 320 may allow a user or administrator to change what appears on the display 312 of the E-ink persistent display 310 through one or more interfaces. These interfaces may allow for a physical connection between a user and the E-ink persistent display or a wireless communication interface with an administrative device, user device, smart device, or other suitable computing device. The power source 330 may be continuously connected to the E-ink persistent display 310.

As discussed elsewhere herein, the E-ink persistent display 310 may maintain the display 312 in the event of a loss of power. In some example embodiments, if the power source 330 shuts off, then the display 312 of the E-ink persistent display 310 may retain the most recent, ultimate, or last displayed information prior to the loss of power. In such example embodiments, the display 312 may be useful for users who want to retrieve or observe information associated with the hardware 302 despite the loss of power from the power source 330. As a non-limiting example, the user may be able to investigate or ascertain the cause of the power loss as it relates to the functioning of the hardware 302 by observing what is displayed on the display 312. The E-ink persistent display 312 may be positioned such that the display 312 is visible to one or more users 340.

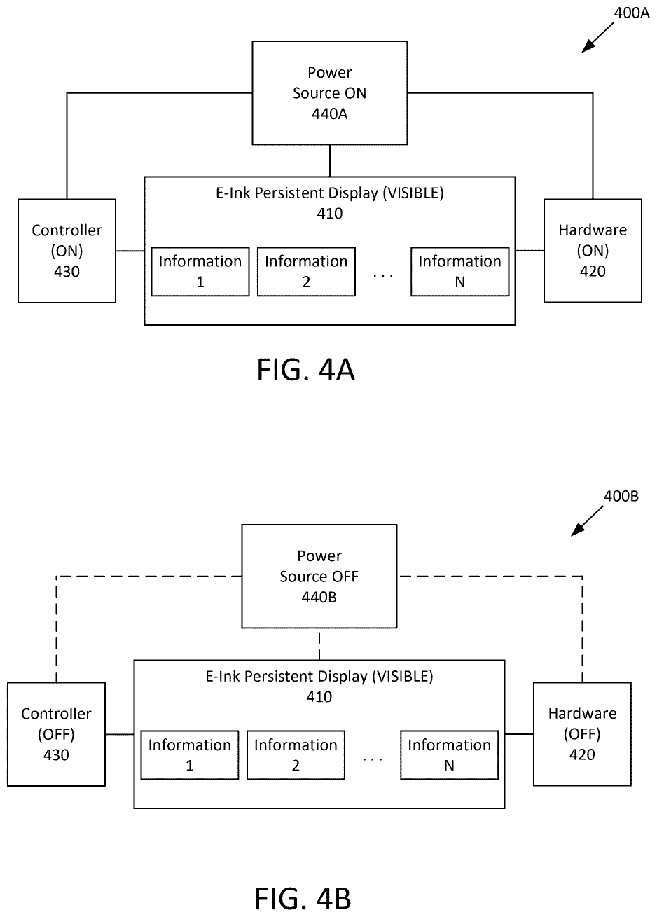

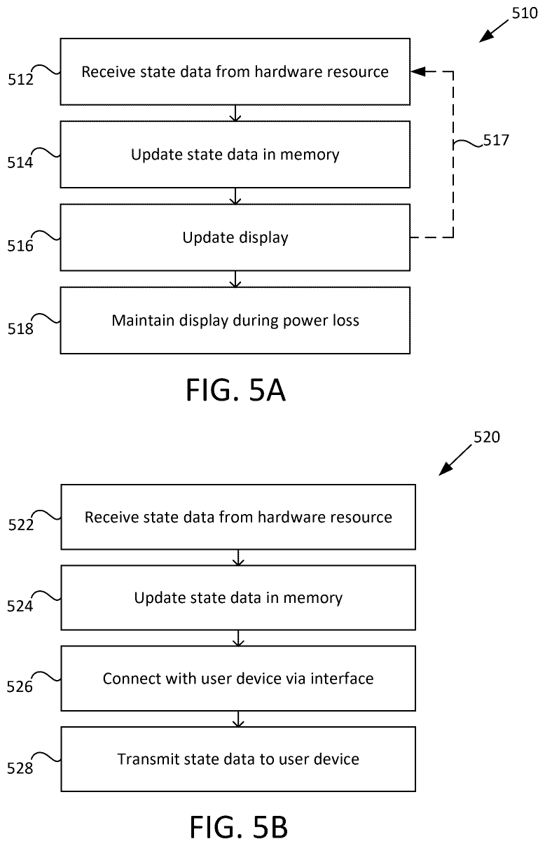

FIG. 4A illustrates a system 400A according to example embodiments. The system 400A may include a power source 440A, a controller 430, hardware 420, and an E-ink persistent display 410. In this example embodiment, the power source may be on. In other words, the power source is powering the controller 430, the E-ink persistent display 410, and the hardware 420. In such example embodiments, the E-ink persistent display 410 may be allowed to update given one or more pieces of state data or information, such as information 1, information 2, and so on, up to any amount of information N. In some example embodiments, information 1 is received during a first time period, then information 2 is received during a second time period, and additional information N is received at some later time period. In other example embodiments, each received piece of information or state data may replace the previous information. For example, information 2 may replace information 1 on the E-ink persistent display 410, and so forth, such that information (N+1) would replace information N on the E-ink persistent display 410.

Due to the nature of E-ink, as described elsewhere herein, the E-ink persistent display 410 relies on the power source 440A to update its display but not necessarily to keep the display on. In other words, the E-ink persistent display 410 may maintain a current display without a power source 440A. For example, in FIG. 4B, illustrating a system 400B, the power source 440B is off, meaning that there is no power flowing to the controller 430, the E-ink persistent display 410, or the hardware 420. Although the controller 430 and the hardware 420 might cease their functionality due to the power source 440B being off, the E-ink persistent display 410 is still visible. In some example embodiments, this might mean that the E-ink persistent display 410 is displaying the most recent, last, or ultimate piece of information received prior to the turning off of the power source 440B. In some example embodiments, this information might be the last received update of state data or information prior to the cutting off of the power source 440B. In such an example, the E-ink persistent display 410 would continue to display this information until the power source was turned back on and the display was updated with a new piece of state data or information. In other example embodiments, the E-ink persistent display 410 may continue to display various kinds of multiple pieces of information, such as all of information one, information two, and so on, up to some predetermined amount of information N.

Although not displayed in FIG. 4B, the E-ink persistent display 410 may further allow a user or administrator with a computing device to change, update, or clear the E-ink persistent display 410 with a computing device configured to interface with the E-ink persistent display 410, such that the E-ink persistent display 410 is updated or changed even without a connection to a power source. In example embodiments, a user may wish to note which E-ink persistent displays have been checked during routine maintenance or inspections. This could be particularly useful in a data center environment where multiple displays are deployed across various hardware components. In some example embodiments, the user might want the display to indicate that a specific check has been completed, such as “Checked: Server Rack 1—All Systems Normal” or “Maintenance Completed: GPU Status OK.” Additionally, the user may want to display reminders or alerts that are relevant to the hardware's operational status, such as “Power Loss Detected—Last Update: 14:30” or “Check Cooling System—Last Maintenance: 2 Days Ago.” This information would allow the user to quickly assess the status of the hardware and any necessary actions that need to be taken, even in the absence of power.

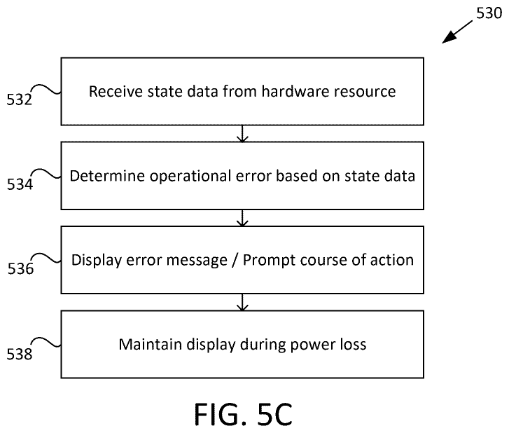

FIG. 5A illustrates a process 510 for updating and maintaining a display of an E-ink persistent display in the presence or absence of power. Each of the actions illustrated in the process 510 may be performed by one or more processors or modules in connection with an E-ink persistent display as described elsewhere herein. In other example embodiments, the actions illustrated in the process 510 may be performed out of order, one or more times, in a different order, or with a greater or fewer number of steps. Various embodiments of the present systems and methods can be carried out on or by any type of system (e.g., a mobile device that may have an embedded camera system) that is suitably equipped, programmed, and configured to carry out the herein-described functions that are primarily described in this disclosure as being carried out on example embodiments of systems describe elsewhere herein. Moreover, additional elements can be present. Furthermore, one or more of the depicted elements can be distributed across multiple functional components, while two or more of the depicted components can be combined into a lesser number of components.

A processor or module associated with the E-ink persistent display may receive 512 one or more pieces of state data or other kinds of information from a hardware resource. In example embodiments, the E-ink persistent display's processor may receive state data from one or more CPUs, GPUs, or servers from a given server rack or other pieces of hardware. As discussed elsewhere herein, this process 510 may occur in a data center with multiple E-ink persistent displays associated with a plurality of hardware resources.

Upon receiving the state data or updated information from the hardware resource, the E-ink persistent display may update 514 the state data in a memory also associated with the E-ink persistent display. The memory of the E-ink persistent display may retain the state data for a predetermined time, allowing it to be both readable and writable by a user or administrator who would like to see a history of the state data or updated information associated with that particular E-ink persistent display. The memory may utilize non-volatile storage technologies, such as flash memory or EEPROM, to maintain state data even when power is lost. This memory could be organized in a structured format, such as a time-stamped log, where each entry records the state data along with a timestamp indicating when the data was received. Users could retrieve this historical log through a user interface, which may be accessible via a web application or a dedicated software tool. The interface could allow users to filter the log by date, type of information, or specific hardware components, enabling efficient access to relevant data.

Once the E-ink persistent display has updated the state data in its memory, the E-ink persistent display may update 516 the display. This updating may include removing some previously displayed information from the display and generating new displayed information on the E-ink persistent display in its place. In other example embodiments, this action may include maintaining existing information displayed on the E-ink persistent display while adding one or more additional pieces of updated information. For instance, the E-ink persistent display could append clarifying information such as “Last Checked: [Date and Time]” or “Status: Operational” to the existing display. The display could also include alerts like “Warning: High CPU Temperature” or “Update Required: Firmware Version 2.3.1.”

Actions 512, 514, and 516 may be repeated one or more times and indeed iterated one or more times, such that the display may receive 517 new or subsequent state data or hardware information from one or more hardware resources multiple times. Each received state data or hardware resource may trigger the updating of the memory of the E-ink persistent display and the updating of the display of the E-ink persistent display one or more times.

In the event of power loss, the E-ink persistent display may be configured such that even during the loss of power connected to the E-ink persistent display, the display may maintain 518 whatever information was last on the display without the need for power. This ability to display information without a connection to power is due to the nature of E-ink, which is displayed due to an electric charge and may only be removed by a subsequent electric charge. Thus, the E-ink persistent display persists even in the event of power loss. This is particularly useful when users want to look at the E-ink persistent display after something has gone wrong with the hardware resource or the server.

FIG. 5B illustrates a process 520 for updating and maintaining a display of an E-ink persistent display in the presence or absence of power. Each of the actions illustrated in the process 520 may be performed by one or more processors or modules in connection with an E-ink persistent display, as described elsewhere herein. In other example embodiments, the actions illustrated in the process 520 may be performed out of order, one or more times, in a different order, or with a greater or fewer number of steps. Various embodiments of the present systems and methods can be carried out on or by any type of system (e.g., a mobile device that may have an embedded camera system) that is suitably equipped, programmed, and configured to carry out the herein-described functions that are primarily described in this disclosure as being carried out on example embodiments of systems describe elsewhere herein. Moreover, additional elements can be present. Furthermore, one or more of the depicted elements can be distributed across multiple functional components, while two or more of the depicted components can be combined into a lesser number of components.

A processor or module associated with the E-ink persistent display may receive 522 one or more pieces of state data or other kinds of information from a hardware resource. In example embodiments, the E-ink persistent display's processor may receive state data from one or more CPUs, GPUs, or servers from a given server rack or other pieces of hardware. As discussed elsewhere herein, this process 520 may occur in a data center with multiple E-ink persistent displays associated with a plurality of hardware resources.

Upon receiving the state data or updated information from the hardware resource, the processor may update 524 the state data in a memory also associated with the E-ink persistent display. The memory of the E-ink persistent display may retain the state data for a predetermined time, allowing it to be both readable and writable by a user or administrator who would like to see a history of the state data or updated information associated with that particular E-ink persistent display. The memory may utilize non-volatile storage technologies, such as flash memory or EEPROM, to maintain state data even when power is lost. This memory could be organized in a structured format, such as a time-stamped log, where each entry records the state data along with a timestamp indicating when the data was received. Users could retrieve this historical log through a user interface, which may be accessible via a web application or a dedicated software tool. The interface could allow users to filter the log by date, type of information, or specific hardware components, enabling efficient access to relevant data.

The E-ink persistent display may connect 526 with a user device via a connection port, a wired connection, a wireless connection, or any other suitable connection. In example embodiments, the user device may include any computer-enabled device such as a reader, scanner, controller, or administrative device. The user device may enable wireless methods such as Bluetooth and near field communication (NFC) to interface with the E-ink persistent display. Upon connecting with the user device, the E-ink persistent display may transmit 528 one or more of the state data to the user device. The E-ink persistent display may receive a token or identification request indicating which state data the user device wants to receive, e.g., the most recently updated state data or some other historical state data. In other embodiments, the user device may interface with the E-ink persistent display to search through the state data history, error log, or any other information discussed herein.

FIG. 5C illustrates a process 530 for updating and maintaining a display of an E-ink persistent display in the presence or absence of power. Each of the actions illustrated in the process 530 may be performed by one or more processors or modules in connection with an E-ink persistent display, as described elsewhere herein. In other example embodiments, the actions illustrated in the process 530 may be performed out of order, one or more times, in a different order, or with a greater or fewer number of steps. Various embodiments of the present systems and methods can be carried out on or by any type of system (e.g., a mobile device that may have an embedded camera system) that is suitably equipped, programmed, and configured to carry out the herein-described functions that are primarily described in this disclosure as being carried out on example embodiments of systems describe elsewhere herein. Moreover, additional elements can be present. Furthermore, one or more of the depicted elements can be distributed across multiple functional components, while two or more of the depicted components can be combined into a lesser number of components.

A processor or module associated with the E-ink persistent display may receive 532 one or more pieces of state data or other kinds of information from a hardware resource. In example embodiments, the E-ink persistent display's processor may receive state data from one or more CPUs, GPUs, or servers from a given server rack or other pieces of hardware. As discussed elsewhere herein, this process 530 may occur in a data center with multiple E-ink persistent displays associated with a plurality of hardware resources.

The E-ink persistent display may determine 534 whether an operational error has occurred based on the state data. In example embodiments, the state data may indicate that a CPU has overheated, triggering a thermal shutdown; a GPU has failed to initialize properly; or a network switch has lost connectivity, causing a disruption in data flow. Based on this operational error, the E-ink persistent display may display 536 an error message corresponding to the operational error including other hardware information such as, e.g., rack number, and time information. In other example embodiments, the E-ink persistent display may prompt a course of action such as “reset connection,” prompting the user to reset a connection between the hardware and one or more corresponding components. In the event that E-ink persistent display's power source is lost, the E-ink persistent display may maintain 538 the display during the power loss.

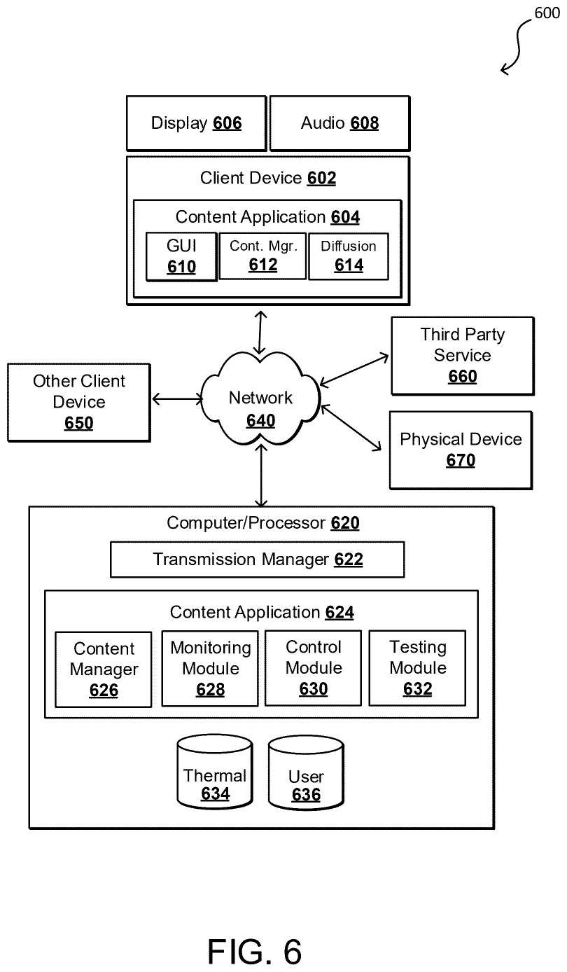

FIG. 6 illustrates an example network configuration 600 of components that can be used to implement aspects of various embodiments, such as to provide, generate, modify, encode, process, fuse, and/or transmit generated image data, calculated measurements, or other such content. In at least one embodiment, a client device 602 can generate or receive data for a session using components of a content application 604 on the client device 602 and data stored locally on that client device. In at least one embodiment, a content application 624 executing on a computer or processor 620 (e.g., a cloud server or control system) may initiate a session associated with at least one client device 602 (e.g., a vehicle or robot), as may use a session manager and user data stored in a user database 636, and can cause content such as liquid coolant or server thermal data to be selected and/or retrieved from a repository 634 to be used by a testing module 632 to calculate one or more performance metrics for a monitoring module 628, which can provide flow data or thermal data to a control module 630 to control a flow or temperature, in an environment where the data is to be used to determine appropriate operation. A content manager 626 may work with at least these various modules to perform testing and analysis, and potentially instruct any actions to be taken in response to a performance metric failing to satisfy an operational requirements. At least a portion of this data or instructional content can be transmitted to the client device 602 and/or a physical device 670 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding content application 604, which may also or alternatively include a graphical user interface 610, a flow monitor module 612, and a control module 614 for use in providing, synthesizing, rendering, compositing, modifying, or using content for presentation, navigation, control, (or other purposes) on or by the client device 602, such as may be transmitted to the physical device 670. In some embodiments, the computer or processor 620 and client device 602 may be able to communicate directly without needing to transmit data over a network 640, in order to avoid issues with latency and availability, etc. A decoder may also be used to decode data received over the network 640 for presentation via client device 602, such as imaging content or performance metrics through a display device 606 and audio, such as corresponding sounds or synthesized speech, through at least one audio playback device 608, such as speakers or headphones. In at least one embodiment, at least some of this content may already be stored on, rendered on, or accessible to client device 602 such that transmission over a network 640 is not required for at least that portion of content, such as where that content (e.g., thermal data) may have been previously downloaded or stored locally on a hard drive or optical disk. In at least one embodiment, a transmission mechanism such as data streaming can be used to transfer this content from the computer or processor 620, or user database 636, to the client device 602. In at least one embodiment, at least a portion of this content can be obtained, enhanced, and/or streamed from another source, such as a third party service 660 or other client device 650, that may also include a content application for generating, updating, enhancing, or providing map content. In at least one embodiment, portions of this functionality can be performed using multiple computing devices, or multiple processors within one or more computing devices, such as may include a combination of CPUs and GPUs (Graphics Processing Unit), (DPUs), (QPUs), a plurality of parallel processing units (PPUs).

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, which sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### DATA CENTER

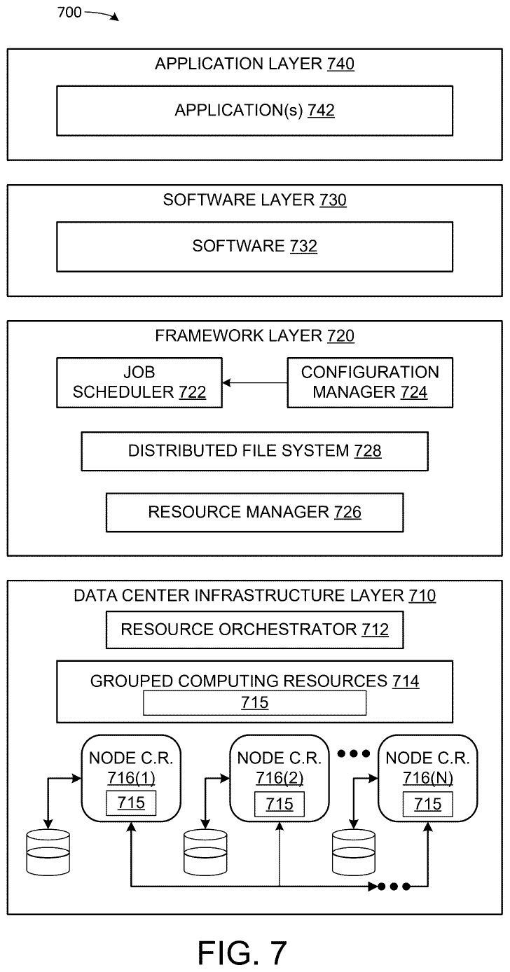

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may use distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 714 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underused and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, DPUs, QPUs, a plurality of parallel processing units (PPUs), or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 7 for inferencing or predicting operations based, at least in part, on weight parameters calculated using neural network training operations, neural network functions and/or architectures, or neural network use cases described herein.

Such components can be used in data centers that with E-ink persistent display devices.

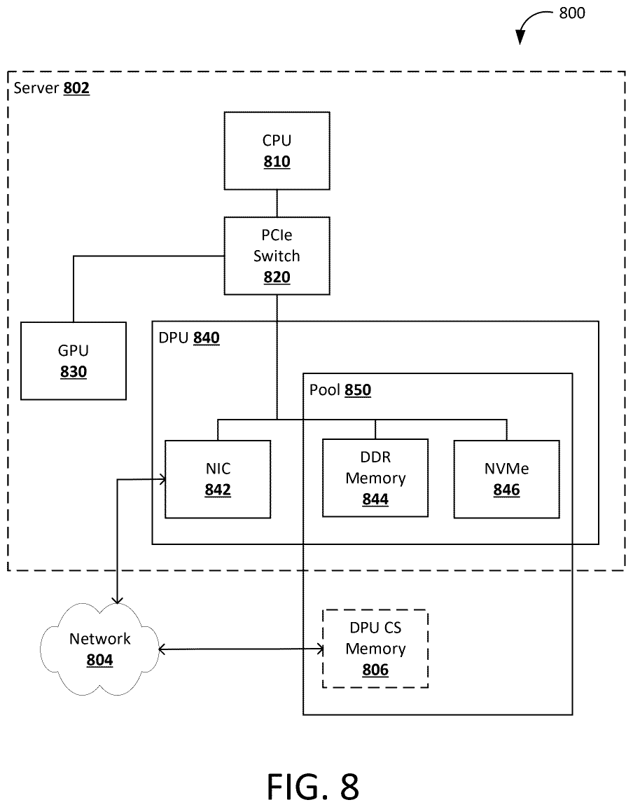

FIG. 8 illustrates an example computing environment 800 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 800 may include a server 802 which may be used to perform HPC workloads, such as AI training or machine learning model training. In an embodiment, the server 802 may be an application instance or a compute node. The server 802 may include a CPU 810 associated with a switch 820, such as a peripheral component interconnect express (PCIe) switch, which may control at least some data transmission over communication paths interconnecting various components. In an embodiment, the CPU 810 may include a root complex processor.

The PCIe switch 820 may also be associated with a GPU 830 and a DPU 840, and may transmit data between at least some of the CPU 810, the GPU 830, the DPU 840, and other components. In an embodiment, the PCIe switch 820 may be associated with more than one GPU or more than one DPU. In another embodiment, the PCIe switch 820 may be located within the DPU 840. The PCIe switch 820 may manage the transfer of at least some data between the CPU 810, the GPU 830, and the DPU 840. In another embodiment, the number of GPUs associated with the PCIe switch 820 may be equal to the number of DPUs associated with the PCIe switch 820. In at least one embodiment, the server 802 may include, without limitation, any number of the CPUs 810, the PCIe switches 820, the GPUs 830, and/or the DPUs 840, in any combination. For example, in at least one embodiment, server 802 could include eight, sixteen, thirty-two, and/or more GPUs 830. In at least one embodiment, communication paths interconnecting various components, including but not limited to the CPU 810, the PCIe switch 820, the GPU 830, and the DPU 840, in FIG. 8 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 840 may include a network interface card (NIC) 842, a DDR memory 844, and a non-volatile memory express (NVMe) device 846. The NIC 842 may be able to interface with a network 804, which may also interface with additional NVMe devices available to the DPU 840, such as over fabric. In an embodiment, the DPU 840 may not include the NVMe device 846. In another embodiment, the NVMe device 846 may be located on the server 802 and not on the DPU 840. In yet another embodiment, the computing environment 800 may include more than one of the NVMe device 846, such as a first NVMe device in the DPU 840 and a second first NVMe device on the server 802 an associated directly with the PCIe switch 820. In an embodiment, the DPU 840 may not include the DDR memory 844 and may include a computational storage services (CSS) in place of, or in addition to, the DDR memory 844. For example, computing environment 800 may include DPU computational storage (CS) memory 806 available to the DPU 840 as part of the CSS. The network 804 may be able to interface with the DPU CS memory 806 through the NIC 842, according to any suitable interface protocol, such as remote direct memory access (RDMA) over Ethernet, InfiniBand, Fiber Channel, etc.

The total memory of the computing environment 800 available for data storage may be expanded through the use of the DPU 840 on nodes of the system. The DPU 840 may have access to a pool 850 of memory already available to the server 802, such as double data rate (DDR) memory, on-board NVMe devices, NVMe devices over fabric, and CS. The pool 850 of memory may include at least one of the DDR memory 844, NVMe 846, and the DPU CS memory 806. The DPU 840 may also be able to access the available memory of other DPUs as part of the pool 850, and other DPUs may be able to access the available memory of DPU 840, such as the pool 850. This available memory can be accessed and utilized for data storage, without the addition of compute resources, such as compute nodes, which would be required using other solutions. The available pool 850 accessible to the DPU 840 may be provisioned for the server 802 to expand the total memory available for data storage, such as to reduce the data storage load on the CPU 810 or the GPU 830, which can instead increase the utilization of their memory for processing. For example, during training of an AI, the model states, residual states, activation functions, and checkpoints can be stored, or offloaded, on the pool 850 accessible to the DPU 840.

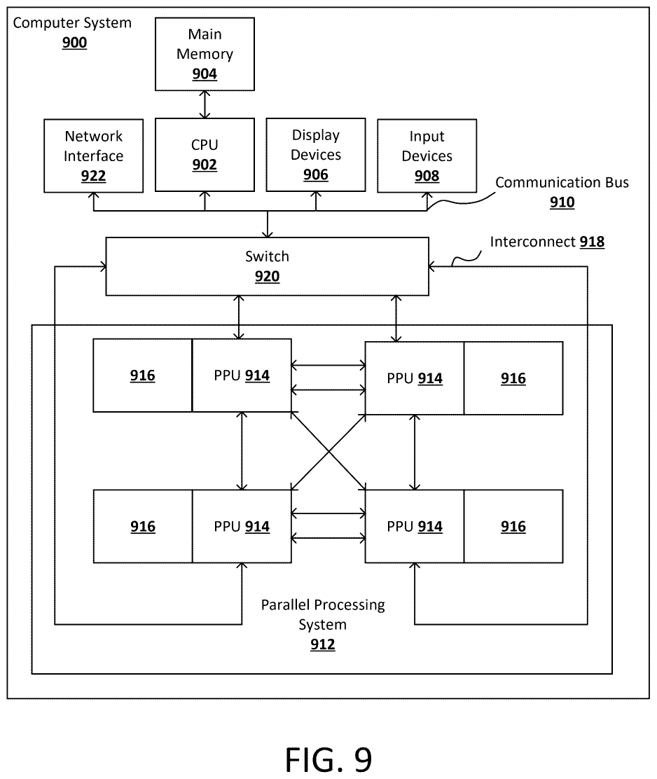

FIG. 9 illustrates a computer system 900, according to at least one embodiment. In at least one embodiment, computer system 900 is configured to implement various processes and methods described throughout this disclosure.

In at least one embodiment, computer system 900 comprises, without limitation, at least one central processing unit (“CPU”) 902 that is connected to a communication bus 910 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 900 includes, without limitation, a main memory 904 and control logic (e.g., implemented as hardware, software, or a combination thereof) and data are stored in main memory 904 which may take form of random access memory (“RAM”). In at least one embodiment, a network interface subsystem (“network interface”) 922 provides an interface to other computing devices and networks for receiving data from and transmitting data to other systems from computer system 900.

In at least one embodiment, computer system 900, in at least one embodiment, includes, without limitation, input devices 908, parallel processing system 912, and display devices 906 which can be implemented using a conventional cathode ray tube (“CRT”), liquid crystal display (“LCD”), light emitting diode (“LED”), plasma display, or other suitable display technologies. In at least one embodiment, user input is received from input devices 908 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 904 and/or secondary storage. Computer programs, if executed by one or more processors, enable system 900 to perform various functions in accordance with at least one embodiment. Memory 904, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous FIGS. are implemented in context of CPU 902; parallel processing system 912; an integrated circuit capable of at least a portion of capabilities of both CPU 902; parallel processing system 912; a chipset (e.g., a group of integrated circuits designed to work and sold as a unit for performing related functions, etc.); and any suitable combination of integrated circuit(s).

In at least one embodiment, architecture and/or functionality of various previous FIGS. are implemented in context of a general computer system, a circuit board system, a game console system dedicated for entertainment purposes, an application-specific system, and more. In at least one embodiment, computer system 900 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 912 includes, without limitation, a plurality of parallel processing units (“PPUs”) 914 and associated memories 916. In at least one embodiment, PPUs 914 are connected to a host processor or other peripheral devices via an interconnect 918 and a switch 920 or multiplexer. In at least one embodiment, parallel processing system 912 distributes computational tasks across PPUs 914 which can be parallelizable-for example, as part of distribution of computational tasks across multiple graphics processing unit (“GPU”) thread blocks. In at least one embodiment, memory is shared and accessible (e.g., for read and/or write access) across some or all of PPUs 914, although such shared memory may incur performance penalties relative to use of local memory and registers resident to a PPU 914. In at least one embodiment, operation of PPUs 914 is synchronized through use of a command such as_syncthreads( ), wherein all threads in a block (e.g., executed across multiple PPUs 914) to reach a certain point of execution of code before proceeding.

Such components can be used in data centers that with E-ink persistent display devices.

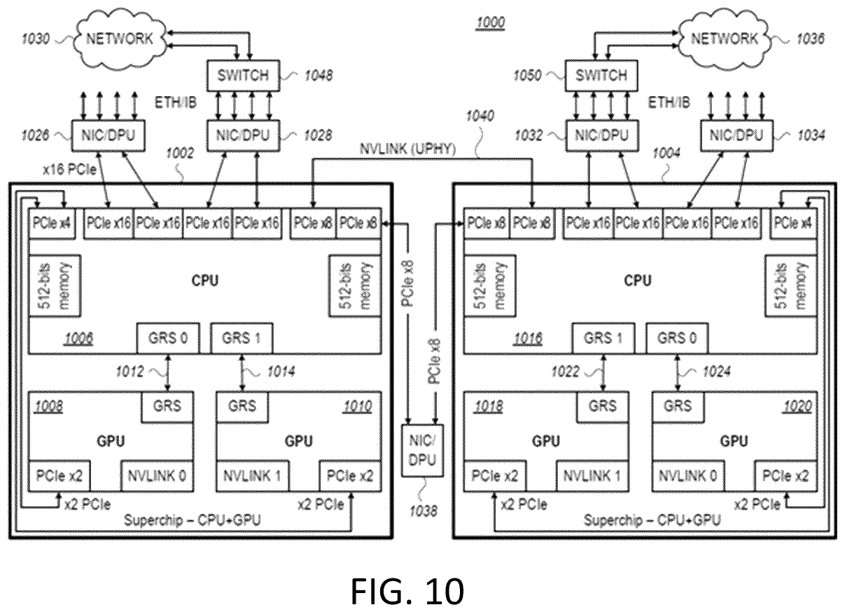

FIG. 10 is a block diagram that schematically illustrates a computing system 1000, e.g., a data center or a High-Performance Computing (HPC) cluster, in accordance with an embodiment that is described herein. System 1000 comprises a plurality of subsystems, e.g., multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 10 also demonstrates an example architecture of a multi-GPU architecture. As illustrated in the FIG., computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 10, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 10, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communicate with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects. The packet switches in FIG. 10 may comprise, for example, Nvidia Quantum-2 switches. The NICs/DPUs in the FIG. may comprise, for example, Nvidia Bluefield DPUs.

In various embodiments, any of the network devices of system 1000, e.g., any of NICs/DPUs 1026, 1028, 1032, 1034 and 1038, and/or any of switches 1048 and 1050, may use ILI packets in accordance with the techniques described herein. Such components can be used in data centers that with E-ink persistent display devices.

### COMPUTER SYSTEMS

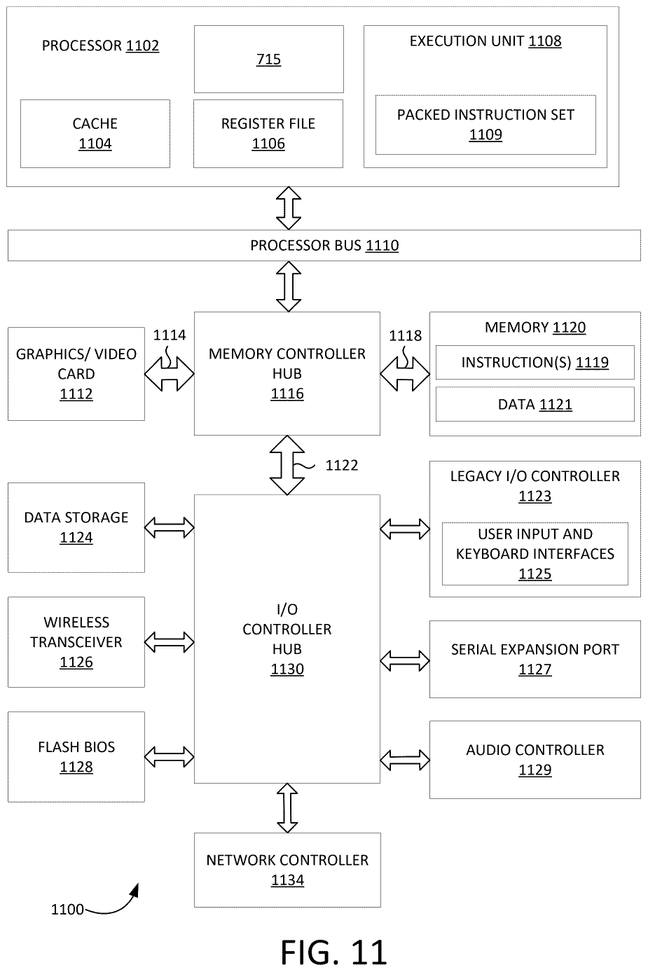

FIG. 11 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 1100 may include, without limitation, a component, such as a processor 1102 to employ execution units including logic to perform algorithms for process data, in accordance with present disclosure, such as in embodiment described herein. In at least one embodiment, computer system 1100 may include processors, such as PENTIUM® Processor family, Xeon™, Itanium®, Xscale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1100 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 1100 may include, without limitation, processor 1102 that may include, without limitation, one or more execution units 1108 to perform machine learning model training and/or inferencing according to techniques described herein. In at least one embodiment, computer system 1100 is a single processor desktop or server system, but in another embodiment, computer system 1100 may be a multiprocessor system. In at least one embodiment, processor 1102 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 1102 may be coupled to a processor bus 1110 that may transmit data signals between processor 1102 and other components in computer system 1100.

In at least one embodiment, processor 1102 may include, without limitation, a Level 1 (“L1”) internal cache memory (“cache”) 1104. In at least one embodiment, processor 1102 may have a single internal cache or multiple levels of internal cache. In at least one embodiment, cache memory may reside external to processor 1102. Other embodiments may also include a combination of both internal and external caches depending on particular implementation and needs. In at least one embodiment, a register file 1106 may store different types of data in various registers including, without limitation, integer registers, floating point registers, status registers, and an instruction pointer register.

In at least one embodiment, execution unit 1108, including, without limitation, logic to perform integer and floating point operations, also resides in processor 1102. In at least one embodiment, processor 1102 may also include a microcode (“ucode”) read only memory (“ROM”) that stores microcode for certain macro instructions. In at least one embodiment, execution unit 1108 may include logic to handle a packed instruction set 1109. In at least one embodiment, by including packed instruction set 1109 in an instruction set of a general-purpose processor, along with associated circuitry to execute instructions, operations used by many multimedia applications may be performed using packed data in processor 1102. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 1108 may also be used in microcontrollers, embedded processors, graphics devices, DSPs, and other types of logic circuits. In at least one embodiment, computer system 1100 may include, without limitation, a memory 1120. In at least one embodiment, memory 1120 may be a Dynamic Random Access Memory (“DRAM”) device, a Static Random Access Memory (“SRAM”) device, a flash memory device, or another memory device. In at least one embodiment, memory 1120 may store instruction(s) 1119 and/or data 1121 represented by data signals that may be executed by processor 1102.

In at least one embodiment, a system logic chip may be coupled to processor bus 1110 and memory 1120. In at least one embodiment, a system logic chip may include, without limitation, a memory controller hub (“MCH”) 1116, and processor 1102 may communicate with MCH 1116 via processor bus 1110. In at least one embodiment, MCH 1116 may provide a high bandwidth memory path 1118 to memory 1120 for instruction and data storage and for storage of graphics commands, data, and textures. In at least one embodiment, MCH 1116 may direct data signals between processor 1102, memory 1120, and other components in computer system 1100 and to bridge data signals between processor bus 1110, memory 1120, and a system I/O interface 1122. In at least one embodiment, a system logic chip may provide a graphics port for coupling to a graphics controller. In at least one embodiment, MCH 1116 may be coupled to memory 1120 through high bandwidth memory path 1118 and a graphics/video card 1112 may be coupled to MCH 1116 through an Accelerated Graphics Port (“AGP”) interconnect 1114.

In at least one embodiment, computer system 1100 may use system I/O interface 1122 as a proprietary hub interface bus to couple MCH 1116 to an I/O controller hub (“ICH”) 1130. In at least one embodiment, ICH 1130 may provide direct connections to some I/O devices via a local I/O bus. In at least one embodiment, a local I/O bus may include, without limitation, a high-speed I/O bus for connecting peripherals to memory 1120, a chipset, and processor 1102. Examples may include, without limitation, an audio controller 1129, a firmware hub (“flash BIOS”) 1128, a wireless transceiver 1126, a data storage 1124, a legacy I/O controller 1123 containing user input and keyboard interfaces 1125, a serial expansion port 1127, such as a Universal Serial Bus (“USB”) port, and a network controller 1134. In at least one embodiment, data storage 1124 may comprise a hard disk drive, a floppy disk drive, a CD-ROM device, a flash memory device, or other mass storage device.

In at least one embodiment, FIG. 11 illustrates a system, which includes interconnected hardware devices or “chips”, whereas in other embodiments, FIG. 11 may illustrate an exemplary SoC. In at least one embodiment, devices illustrated in FIG. 11 may be interconnected with proprietary interconnects, standardized interconnects (e.g., PCIe) or some combination thereof. In at least one embodiment, one or more components of computer system 1100 are interconnected using compute express link (CXL) interconnects.

Inference and/or training logic 715 are used to perform inferencing and/or training operations associated with one or more embodiments. In at least one embodiment, inference and/or training logic 715 may be used in system FIG. 11 for inferencing or predicting operations based, at least in part, on weight parameters calculated using neural network training operations, neural network functions and/or architectures, or neural network use cases described herein.

Embodiments presented herein can manage various aspects of an operational management system for a computing environment, as may relate to the cleaning, cutover, or adjustment of one or more cooling or power systems.

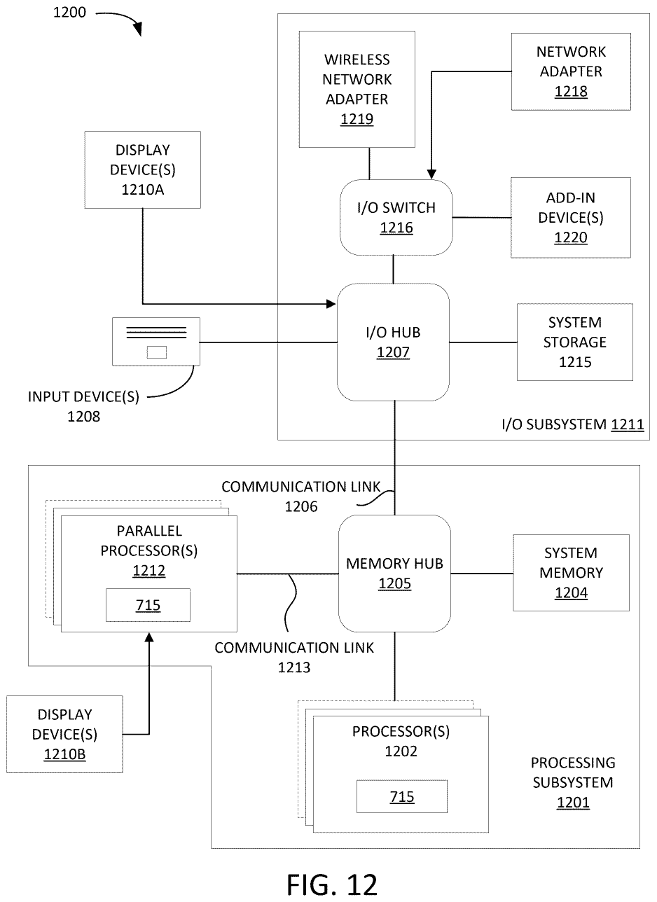

FIG. 12 is a block diagram illustrating a computing system 1200 according to at least one embodiment. In at least one embodiment, computing system 1200 includes a processing subsystem 1201 having one or more processor(s) 1202 and a system memory 1204 communicating via an interconnection path that may include a memory hub 1205. In at least one embodiment, memory hub 1205 may be a separate component within a chipset component or may be integrated within one or more processor(s) 1202. In at least one embodiment, memory hub 1205 couples with an I/O subsystem 1211 via a communication link 1206. In at least one embodiment, I/O subsystem 1211 includes an I/O hub 1207 that can enable computing system 1200 to receive input from one or more input device(s) 1208. In at least one embodiment, I/O hub 1207 can enable a display controller, which may be included in one or more processor(s) 1202, to provide outputs to one or more display device(s) 1210A. In at least one embodiment, one or more display device(s) 1210A coupled with I/O hub 1207 can include a local, internal, or embedded display device.

In at least one embodiment, processing subsystem 1201 includes one or more parallel processor(s) 1212 coupled to memory hub 1205 via a bus or other communication link 1213. In at least one embodiment, communication link 1213 may use one of any number of standards based communication link technologies or protocols, such as but not limited to PCI Express, or may be a vendor-specific communications interface or communications fabric. In at least one embodiment, one or more parallel processor(s) 1212 form a computationally focused parallel or vector processing system that can include a large number of processing cores and/or processing clusters, such as a many-integrated core (MIC) processor. In at least one embodiment, some or all of parallel processor(s) 1212 form a graphics processing subsystem that can output pixels to one of one or more display device(s) 1210A coupled via I/O hub 1207. In at least one embodiment, parallel processor(s) 1212 can also include a display controller and display interface (not shown) to enable a direct connection to one or more display device(s) 1210B. In at least one embodiment, parallel processor(s) 1212 include one or more cores, such as graphics cores 1200 discussed herein.

In at least one embodiment, a system storage unit 1215 can connect to I/O hub 1207 to provide a storage mechanism for computing system 1200. In at least one embodiment, an I/O switch 1216 can be used to provide an interface mechanism to enable connections between I/O hub 1207 and other components, such as a network adapter 1218 and/or a wireless network adapter 1219 that may be integrated into platform, and various other devices that can be added via one or more add-in device(s) 1220. In at least one embodiment, network adapter 1218 can be an Ethernet adapter or another wired network adapter. In at least one embodiment, wireless network adapter 1219 can include one or more of a Wi-Fi, Bluetooth, near field communication (NFC), or other network device that includes one or more wireless radios.

In at least one embodiment, computing system 1200 can include other components not explicitly shown, including USB or other port connections, optical storage drives, video capture devices, and like, may also be connected to I/O hub 1207. In at least one embodiment, communication paths interconnecting various components in FIG. 12 may be implemented using any suitable protocols, such as PCI (Peripheral Component Interconnect) based protocols (e.g., PCI-Express), or other bus or point-to-point communication interfaces and/or protocol(s), such as NV-Link high-speed interconnect, or interconnect protocols.

In at least one embodiment, parallel processor(s) 1212 incorporate circuitry optimized for graphics and video processing, including, for example, video output circuitry, and constitutes a graphics processing unit (GPU), e.g., parallel processor(s) 1212 includes graphics core 1200. In at least one embodiment, parallel processor(s) 1212 incorporate circuitry optimized for general purpose processing. In at least embodiment, components of computing system 1200 may be integrated with one or more other system elements on a single integrated circuit. For example, in at least one embodiment, parallel processor(s) 1212, memory hub 1205, processor(s) 1202, and I/O hub 1207 can be integrated into a system on chip (SoC) integrated circuit. In at least one embodiment, components of computing system 1200 can be integrated into a single package to form a system in package (SIP) configuration. In at least one embodiment, at least a portion of components of computing system 1200 can be integrated into a multi-chip module (MCM), which can be interconnected with other multi-chip modules into a modular computing system.

Inference and/or training logic 715 are used to perform inferencing and/or training operations associated with one or more embodiments. In at least one embodiment, inference and/or training logic 715 may be used in system FIG. 12 for inferencing or predicting operations based, at least in part, on weight parameters calculated using neural network training operations, neural network functions and/or architectures, or neural network use cases described herein.

Embodiments presented herein can manage various aspects of an operational management system for a computing environment, as may relate to the cleaning, cutover, or adjustment of one or more cooling or power systems.

### PROCESSORS

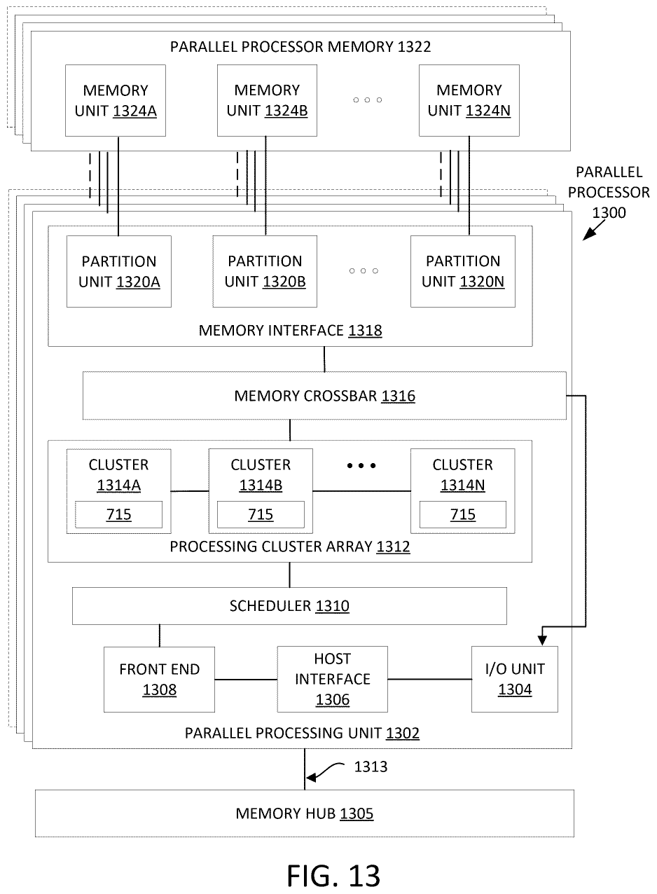

FIG. 13 illustrates a parallel processor 1300 according to at least one embodiment. In at least one embodiment, various components of parallel processor 1300 may be implemented using one or more integrated circuit devices, such as programmable processors, application specific integrated circuits (ASICs), or field programmable gate arrays (FPGA). In at least one embodiment, illustrated parallel processor 1300 is a variant of one or more parallel processor(s) 1302 shown in FIG. 13 according to an exemplary embodiment. In at least one embodiment, a parallel processor 1300 includes one or more graphics cores 1200.

In at least one embodiment, parallel processor 1300 includes a parallel processing unit 1302. In at least one embodiment, parallel processing unit 1302 includes an I/O unit 1304 that enables communication with other devices, including other instances of parallel processing unit 1302. In at least one embodiment, I/O unit 1304 may be directly connected to other devices. In at least one embodiment, I/O unit 1304 connects with other devices via use of a hub or switch interface, such as a memory hub 1305. In at least one embodiment, connections between memory hub 1305 and I/O unit 1304 form a communication link 1313. In at least one embodiment, I/O unit 1304 connects with a host interface 1306 and a memory crossbar 1316, where host interface 1306 receives commands directed to performing processing operations and memory crossbar 1316 receives commands directed to performing memory operations.

In at least one embodiment, when host interface 1306 receives a command buffer via I/O unit 1304, host interface 1306 can direct work operations to perform those commands to a front end 1308. In at least one embodiment, front end 1308 couples with a scheduler 1310 (which may be referred to as a sequencer), which is configured to distribute commands or other work items to a processing cluster array 1312. In at least one embodiment, scheduler 1310 ensures that processing cluster array 1312 is properly configured and in a valid state before tasks are distributed to a cluster of processing cluster array 1312. In at least one embodiment, scheduler 1310 is implemented via firmware logic executing on a microcontroller. In at least one embodiment, microcontroller implemented scheduler 1310 is configurable to perform complex scheduling and work distribution operations at coarse and fine granularity, enabling rapid preemption and context switching of threads executing on processing array 1312. In at least one embodiment, host software can prove workloads for scheduling on processing cluster array 1312 via one of multiple graphics processing paths. In at least one embodiment, workloads can then be automatically distributed across processing array cluster 1312 by scheduler 1310 logic within a microcontroller including scheduler 1310.

In at least one embodiment, processing cluster array 1312 can include up to “N” processing clusters (e.g., cluster 1314A, cluster 1314B, through cluster 1314N), where “N” represents a positive integer (which may be a different integer “N” than used in other figures). In at least one embodiment, each cluster 1314A-1314N of processing cluster array 1312 can execute a large number of concurrent threads. In at least one embodiment, scheduler 1310 can allocate work to clusters 1314A-1314N of processing cluster array 1312 using various scheduling and/or work distribution algorithms, which may vary depending on workload arising for each type of program or computation. In at least one embodiment, scheduling can be handled dynamically by scheduler 1310, or can be assisted in part by compiler logic during compilation of program logic configured for execution by processing cluster array 1312. In at least one embodiment, different clusters 1314A-1314N of processing cluster array 1312 can be allocated for processing different types of programs or for performing different types of computations.

In at least one embodiment, processing cluster array 1312 can be configured to perform various types of parallel processing operations. In at least one embodiment, processing cluster array 1312 is configured to perform general-purpose parallel compute operations. For example, in at least one embodiment, processing cluster array 1312 can include logic to execute processing tasks including filtering of video and/or audio data, performing modeling operations, including physics operations, and performing data transformations.

In at least one embodiment, processing cluster array 1312 is configured to perform parallel graphics processing operations. In at least one embodiment, processing cluster array 1312 can include additional logic to support execution of such graphics processing operations, including but not limited to, texture sampling logic to perform texture operations, as well as tessellation logic and other vertex processing logic. In at least one embodiment, processing cluster array 1312 can be configured to execute graphics processing related shader programs such as but not limited to, vertex shaders, tessellation shaders, geometry shaders, and pixel shaders. In at least one embodiment, parallel processing unit 1302 can transfer data from system memory via I/O unit 1304 for processing. In at least one embodiment, during processing, transferred data can be stored to on-chip memory (e.g., parallel processor memory 1322) during processing, then written back to system memory.

In at least one embodiment, when parallel processing unit 1302 is used to perform graphics processing, scheduler 1310 can be configured to divide a processing workload into approximately equal sized tasks, to better enable distribution of graphics processing operations to multiple clusters 1314A-1314N of processing cluster array 1312. In at least one embodiment, portions of processing cluster array 1312 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 1314A-1314N may be stored in buffers to allow intermediate data to be transmitted between clusters 1314A-1314N for further processing.

In at least one embodiment, processing cluster array 1312 can receive processing tasks to be executed via scheduler 1310, which receives commands defining processing tasks from front end 1308. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 1310 may be configured to fetch indices corresponding to tasks or may receive indices from front end 1308. In at least one embodiment, front end 1308 can be configured to ensure processing cluster array 1312 is configured to a valid state before a workload specified by incoming command buffers (e.g., batch-buffers, push buffers, etc.) is initiated.

In at least one embodiment, each of one or more instances of parallel processing unit 1302 can couple with a parallel processor memory 1322. In at least one embodiment, parallel processor memory 1322 can be accessed via memory crossbar 1316, which can receive memory requests from processing cluster array 1312 as well as I/O unit 1304. In at least one embodiment, memory crossbar 1316 can access parallel processor memory 1322 via a memory interface 1318. In at least one embodiment, memory interface 1318 can include multiple partition units (e.g., partition unit 1320A, partition unit 1320B, through partition unit 1320N) that can each couple to a portion (e.g., memory unit) of parallel processor memory 1322. In at least one embodiment, a number of partition units 1320A-1320N is configured to be equal to a number of memory units, such that a first partition unit 1320A has a corresponding first memory unit 1324A, a second partition unit 1320B has a corresponding memory unit 1324B, and an N-th partition unit 1320N has a corresponding N-th memory unit 1324N. In at least one embodiment, a number of partition units 1320A-1320N may not be equal to a number of memory units.

In at least one embodiment, memory units 1324A-1324N can include various types of memory devices, including dynamic random access memory (DRAM) or graphics random access memory, such as synchronous graphics random access memory (SGRAM), including graphics double data rate (GDDR) memory. In at least one embodiment, memory units 1324A-1324N may also include 3D stacked memory, including but not limited to high bandwidth memory (HBM), HBM2e, or HDM3. In at least one embodiment, render targets, such as frame buffers or texture maps may be stored across memory units 1324A-1324N, allowing partition units 1320A-1320N to write portions of each render target in parallel to efficiently use available band width of parallel processor memory 1322. In at least one embodiment, a local instance of parallel processor memory 1322 may be excluded in favor of a unified memory design that uses system memory in conjunction with local cache memory.

In at least one embodiment, any one of clusters 1314A-1314N of processing cluster array 1312 can process data that will be written to any of memory units 1324A-1324N within parallel processor memory 1322. In at least one embodiment, memory crossbar 1316 can be configured to transfer an output of each cluster 1314A-1314N to any partition unit 1320A-1320N or to another cluster 1314A-1314N, which can perform additional processing operations on an output. In at least one embodiment, each cluster 1314A-1314N can communicate with memory interface 1318 through memory crossbar 1316 to read from or write to various external memory devices. In at least one embodiment, memory crossbar 1316 has a connection to memory interface 1318 to communicate with I/O unit 1304, as well as a connection to a local instance of parallel processor memory 1322, enabling processing units within different processing clusters 1314A-1314N to communicate with system memory or other memory that is not local to parallel processing unit 1302. In at least one embodiment, memory crossbar 1316 can use virtual channels to separate traffic streams between clusters 1314A-1314N and partition units 1320A-1320N.

In at least one embodiment, multiple instances of parallel processing unit 1302 can be provided on a single add-in card, or multiple add-in cards can be interconnected. In at least one embodiment, different instances of parallel processing unit 1302 can be configured to interoperate even if different instances have different numbers of processing cores, different amounts of local parallel processor memory, and/or other configuration differences. For example, in at least one embodiment, some instances of parallel processing unit 1302 can include higher precision floating point units relative to other instances. In at least one embodiment, systems incorporating one or more instances of parallel processing unit 1302 or parallel processor 1300 can be implemented in a variety of configurations and form factors, including but not limited to desktop, laptop, or handheld personal computers, servers, workstations, game consoles, and/or embedded systems.

Inference and/or training logic 715 are used to perform inferencing and/or training operations associated with one or more embodiments. In at least one embodiment, inference and/or training logic 715 may be used in system FIG. 13 for inferencing or predicting operations based, at least in part, on weight parameters calculated using neural network training operations, neural network functions and/or architectures, or neural network use cases described herein.

Various embodiments can be described by the following clauses:
1. A display device, comprising:
a persistent display;
a data connection to receive state data from a hardware device with which the persistent display is associated; and
circuitry to allow the persistent display to display the state data, wherein the state data displayed on the persistent display is able to be updated dynamically based in part upon one or more changes to the hardware device during operation, and wherein at least a portion of the state data displayed on the persistent display is able to remain visible in an event of a failure of the hardware device.
2. The display device of clause 1, wherein the most recent update to the state data displayed on the persistent display is able to remain visible even if there is no power provided to the display device.
3. The display device of clause 1, wherein the display device further comprises:
an embedded processor and memory for processing the state data before the state data is displayed on the persistent display, and storing at least a most recent portion of the state data.
4. The display device of clause 3, wherein the display device further comprises:
an input element allowing a user to cause the most recent portion of the state data to be displayed on the persistent display.
5. The display device of clause 1, wherein the display device is a flexible device that is able to be attached to an external surface of the hardware device.
6. The display device of clause 1, wherein the display device is located within an externally-accessible slot in the hardware device, and wherein the display device is able to be at least partially removed from the externally-accessible slot to allow the state data to be read from the persistent display.
7. The display device of clause 1, wherein the persistent display is one of an electronic paper display, an electrophoretic display, a plasmonic display, an electrowetted display, or an interferometric display.
8. The display device of clause 1, wherein the display device includes at least one wireless communication component to allow requests for state data to be received to the display device through at least one type of wireless communication.
9. The display device of clause 1, wherein the state data includes at least one of a serial number, manufacturer, device model, current software configuration, current hardware configuration, error code, post code, log message, session identifier, user identifier, or recently completed task identifier.
10. A tag for a hardware resource, comprising:
an electronic paper display; and
a processing unit to process received state data for the hardware resource and cause at least a selected portion of the state data to be displayed on the electronic paper display,
wherein the processing unit is able to receive the state data from the hardware resource and dynamically update the portion of the state data that is displayed on the electronic paper display, and wherein the portion of the state data that is displayed on the electronic paper display is able to remain visibly displayed on the electronic paper display even if power or communication from the hardware resource is lost.
11. The tag of clause 10, wherein the most recent update to the state data displayed on the electronic paper display is able to remain visible even if there is no power provided to the electronic paper display.
12. The tag of clause 10, further comprising:
an embedded processor and memory for processing the state data before the state data is displayed on the electronic paper display, and storing at least a most recent portion of the state data.
13. The tag of clause 10, further comprising an input element allowing a user to cause the most recent portion of the state data to be displayed on the electronic paper display.
14. The tag of clause 10, wherein the tag is a flexible device that is able to be attached to an external surface of the hardware resource.
15. The tag of clause 10, wherein the tag is located within an externally-accessible slot in the hardware resource, and wherein the tag is able to be at least partially removed from the externally-accessible slot to allow the state data to be read from the electronic paper display.
16. At least one processor comprising one or more logical units to receive state data from a hardware resource and dynamically update a portion of the state data that is displayed on an electronic paper display, and wherein the portion of the state data that is displayed on the electronic paper display is able to remain visibly displayed on the electronic paper display even if power or communication from the hardware resource is lost.
17. The processor of clause 16, wherein the most recent update to the state data displayed on the electronic paper display is able to remain visible even if there is no power provided to the electronic paper display.
18. The processor of clause 16, wherein the electronic paper display further comprises:
an embedded processor and memory for processing the state data before the state data is displayed on the electronic paper display, and storing at least a most recent portion of the state data.
19. The processor of clause 16, wherein the electronic paper display further comprises:
an input element allowing a user to cause the most recent portion of the state data to be displayed on the electronic paper display.
20. The processor of clause 16, wherein the electronic paper display is a flexible device that is able to be attached to an external surface of the hardware resource.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

In at least one embodiment, data center may use CPUs, application-specific integrated circuits (ASICs), GPUs, FPGAs, DPUs, QPUs, a plurality of parallel processing units (PPUs), or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

(more general boilerplate) In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU, DPU, QPU, a plurality of parallel processing units (PPUs). A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

1. A display device, comprising:
a persistent display;
a data connection to receive state data from a hardware device with which the persistent display is associated; and
circuitry, including a processor and a memory, to store at least a most recent portion of the state data and to process the state data before allowing the persistent display to display the state data, wherein the state data displayed on the persistent display is able to be updated based in part upon one or more changes to the hardware device during operation, and wherein at least a portion of the state data displayed on the persistent display is able to remain visible in an event of a failure of the hardware device.

2. The display device of claim 1, wherein the most recent portion of the state data displayed on the persistent display is able to remain visible even if there is no power provided to the display device.

3. (canceled)

4. The display device of claim 1, wherein the display device further comprises:
an input element allowing a user to cause the most recent portion of the state data to be displayed on the persistent display.

5. The display device of claim 1, wherein the display device is a flexible device that is able to be attached to an external surface of the hardware device.

6. The display device of claim 1, wherein the display device is located within an externally-accessible slot in the hardware device, and wherein the display device is able to be at least partially removed from the externally-accessible slot to allow the state data to be read from the persistent display.

7. The display device of claim 1, wherein the persistent display is one of an electronic paper display, an electrophoretic display, a plasmonic display, an electrowetted display, or an interferometric display.

8. The display device of claim 1, wherein the display device includes at least one wireless communication component to allow requests for state data to be received to the display device through at least one type of wireless communication.

9. The display device of claim 1, wherein the state data includes at least one of a serial number, manufacturer, device model, current software configuration, current hardware configuration, error code, post code, log message, session identifier, user identifier, or recently completed task identifier.

10. A tag for a hardware resource, comprising:
an electronic paper display; and
a processing unit to process received state data for the hardware resource and cause at least a selected portion of the state data to be displayed on the electronic paper display; and
a memory to store at least a most recent portion of the state data,
wherein the processing unit is able to receive the state data from the hardware resource and update the portion of the state data that is displayed on the electronic paper display, and wherein the portion of the state data that is displayed on the electronic paper display is able to remain visibly displayed on the electronic paper display even if power or communication from the hardware resource is lost.

11. The tag of claim 10, wherein the most recent portion of the state data displayed on the electronic paper display is able to remain visible even if there is no power provided to the electronic paper display.

12. (canceled)

13. The tag of claim 10, further comprising an input element allowing a user to cause the most recent portion of the state data to be displayed on the electronic paper display.

14. The tag of claim 10, wherein the tag is a flexible device that is able to be attached to an external surface of the hardware resource.

15. The tag of claim 10, wherein the tag is located within an externally-accessible slot in the hardware resource, and wherein the tag is able to be at least partially removed from the externally-accessible slot to allow the state data to be read from the electronic paper display.

16. At least one processor in an electronic paper display and comprising one or more logical units to receive state data from a hardware resource, store at least a most recent portion of the state data, and update a portion of the state data that is displayed on the electronic paper display, and wherein the portion of the state data that is displayed on the electronic paper display is able to remain visibly displayed on the electronic paper display even if power or communication from the hardware resource is lost.

17. The processor of claim 16, wherein the most recent portion of the state data displayed on the electronic paper display is able to remain visible even if there is no power provided to the electronic paper display.

18. (canceled)

19. The processor of claim 16, wherein the electronic paper display further comprises:
an input element allowing a user to cause the most recent portion of the state data to be displayed on the electronic paper display.

20. The processor of claim 16, wherein the electronic paper display is a flexible device that is able to be attached to an external surface of the hardware resource.
